(19) United States
(12) Patent Application Publication
(10) Pub. No.: US 2016/0312475 A1
(43) Pub. Date: Oct. 27, 2016

(54) MINERAL FIBER CEILING TILE

(71) Applicant: Tower IPCO Co., Ltd., Dublin 2 (IE)

(72) Inventor: Norman STONE, Harrison, NY (US)

(21) Appl. No.: 15/059,090

(22) Filed: Mar. 2, 2016

Related U.S. Application Data
(60) Provisional application No. 62/152,269, filed on Apr. 24, 2015.

(51) Int. Cl. E04F 13/077; E04B 1/66; B32B 37/14; E04B 9/04

(52) U.S. Cl. CPC E04F 13/077; E04B 9/045; E04B 9/0428; E04B 1/665; B32B 37/14; B32B 2419/04

(57) ABSTRACT

The ceiling tile includes a rigid layer of mineral fiber material having a display surface and an opposite surface. The opposite surface of the rigid layer is covered with a facing that is formed with a metallic material that is preferably an aluminum construction. When the tile is installed in a ceiling, the display surface is the viewable surface. The facing forms a moisture resistant seal on the opposite surface of the rigid layer. The entire peripheral edge of the tile and the marginal portions of the display surface and the facing surface are covered by a plastic leak. tight tape that forms a gas tight seal and a moisture resistant seal at the peripheral edge of the ceiling tile.

### BACKGROUND OF THE INVENTION

### Field of the Invention

This invention is directed to a ceiling tile which can be used for suspended or hung ceiling installations, and more particularly to a novel mineral fiber ceiling tile that can resist breakage and moisture damage.

Ceiling tiles made with mineral fiber are known in the art and are also known to absorb moisture which often results in discoloration and/or staining of the tile.

Thus, mineral fiber ceiling tiles may require replacement if used in areas with relatively high moisture levels such as basements, garages, and rooms with overhead pipes.

If moisture condenses on overhead pipes that are concealed by ceiling tiles the condensation can drip from the surface of the pipe onto the ceiling tile and cause discoloration and/or damage to the ceiling tile.

Mineral fiber ceiling tiles are also subject to breakage because their structure is generally brittle and inflexible. Therefore, a mineral fiber ceiling tile must be carefully handled and can require special packaging to help avoid the breakage during transport from one location to another.

The present invention solves the problem of moisture staining or discoloring the ceiling tile by provision of a novel moisture resistant facing the back surface of the tile and a novel water resistant tape at the edges of the tile. The tile facing and edge protection tape also reinforce the ceiling tile to help it resist breakage and edge damage.

### DESCRIPTION OF THE DRAWINGS

In the accompanying drawings,

FIG. 1 is a simplified schematic perspective view of a ceiling tile incorporating one embodiment of the invention;

FIG. 2 is a simplified schematic perspective view of the ceiling tile and a fragmentary portion of edge protection tape at an initial taping stage;

FIG. 4 is a simplified side view of the ceiling tile laminate.

Corresponding reference numbers indicate corresponding parts throughout the several views of the drawings.

Referring to the drawings, a ceiling tile incorporating one embodiment of the invention is generally indicated by the reference number 10 in FIG.

The ceiling tile 10 is of a polygonal shape, and is preferably in the form of a square or elongated rectangle, although other geometric shapes are also feasible.

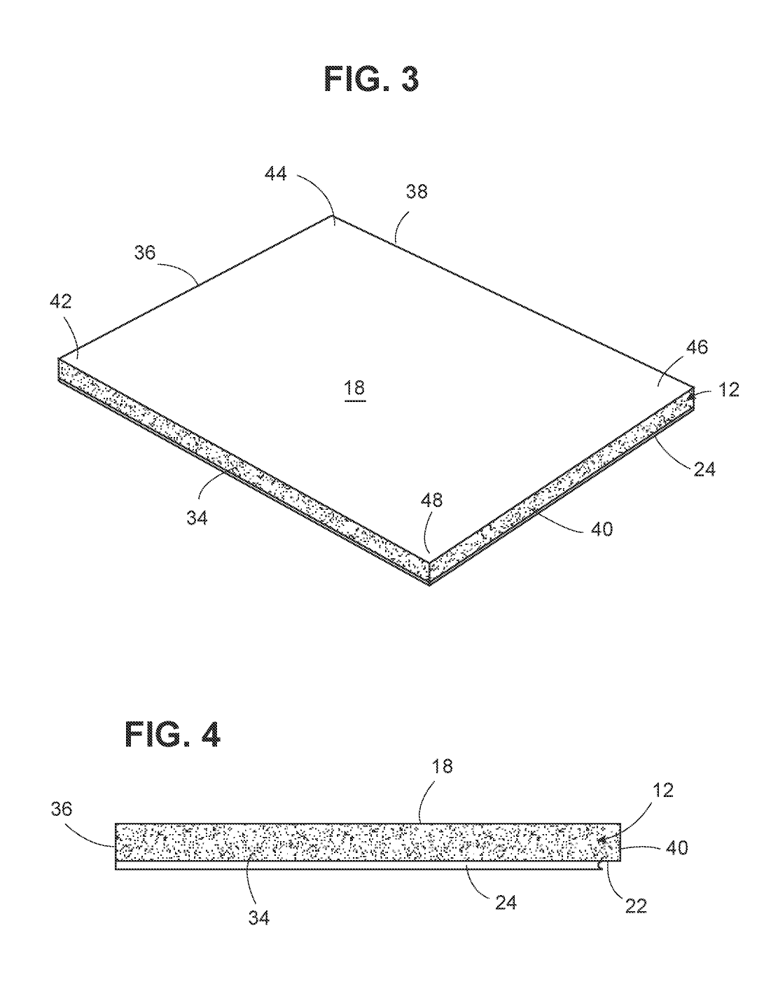

The ceiling tile 10 includes an inflexible layer 12 (FIG. 2) of mineral fiber which can be approximately 13-18 mm thick, and is preferably approximately 15 mm thick. The mineral fiber layer 12 is made in any suitable known manner and includes an exposed front surface 18 and an opposite unexposed back surface 22 (FIG. 4). The exposed front surface 18 can include sponge-like porosities or indentations (not shown) and/or random perforations (not shown).

The porosities, perforations and indentations provide the exposed front surface 18 of the mineral fiber layer 12 with a decorative appearance, and also help the ceiling tile 10 to dampen or absorb sound.

The unexposed opposite surface 22 (FIG. 4) of the mineral fiber layer 12 is covered with a facing 24 preferably formed of a metallic material that is bonded to the unexposed surface 22 of the mineral fiber layer.

A suitable adhesive for bonding the facing 24 to the unexposed surface of the mineral fiber layer 12 by means well known in the art can include the following components:

| Component | Weight % |
|---|---|
| Vinyl acetate acrylate | 26.5 |
| Polyurethane | 11.5 |
| Resin | 22.5 |
| Starch | 19.5 |
| Mineral spirits | 18.5 |
| Defoaming agent | 0.5 |
| Anticorrosive agent | 1 |

The metallic facing 24 is preferably made of an aluminum construction. One preferred aluminum construction is a known aluminum foil facing having a thickness of approximately 7 microns with a known tri-directional fiberglass scrim on one surface of the foil and a known bondable kraft paper base on the other surface of the aluminum foil. The kraft paper portion of the facing 24 is bonded to the surface 22 of the mineral fiber layer 12.

The facing 24 can also be formed of a known aluminum composite that includes a combination of aluminum powder and polyethylene, wherein the aluminum powder comprises approximately 1% to 3% by weight of the composite.

The mineral fiber layer 12 has four peripheral side edges 34, 36, 38, and 40 (FIG. 3), the intersections of which define four corner portions 42, 44, 46, and 48. The corner portions 42, 44, 46 and 48 of the mineral fiber layer 12 are the areas of the tile 10 that are most vulnerable to breakage, especially if the tile 10 is handled at one of the corners 42 44, 46 and 48, and not supported anywhere else.

Tile breakage as a result of customer handling is a vexing problem at some self-service retail establishments where customers may cause inadvertent damage to the tile when they inspect the tile.

It is known that indoor humidity or moisture levels are usually higher in the basement area of a private home or the basement area of multi-level structure compared with humidity readings in upper levels of the private home or multi-level structure. Rooms with overhead pipes that are subject to surface condensation also have relatively high humidity levels. It is also known that conventional mineral fiber ceiling tiles tend to degrade in high moisture or high humidity locations because of moisture related damage.

Thus, since unfinished ceilings in relatively high humidity environments, and the areas around overhead pipes can harbor moisture, such moisture is likely to penetrate into a ceiling tile that covers the unfinished ceiling or conceals overhead pipes. Moisture or water penetration in a mineral fiber ceiling tile usually occurs at the unexposed back surface of the ceiling tile which faces the unfinished ceiling and overhead water pipes. Moisture or water that penetrates the back surface of the ceiling tile can accumulate in the tile and migrate from the unexposed back surface of the tile toward the exposed front surface that is visible to occupants of the space below the ceiling tile. The migration of moisture and water in a ceiling tile will eventually cause unsightly and permanent discoloration or staining of the visible front surface of the ceiling tile. Stained ceiling tiles usually cannot be repaired and are thus replaced if desired.

Applicant has found that by bonding the water resistant aluminum construction facing 24 to the unexposed back surface 22 of the mineral fiber ceiling tile 10, the problem of moisture penetration into the back surface of the tile is substantially reduced because the aluminum construction facing 24 acts as a barrier against moisture penetration.

The aluminum construction facing 24 on the unexposed back surface 22 of the mineral fiber layer 12 also helps reinforce the tile 10 against breakage at the corners 42, 44 46 and 48 and at other areas of the tile 10 when the tile 10 is handled or is being packaged for transport.

Applicant has also found that the aluminum construction facing 24 provides dimensional stability for the tile 10 and reduces potential sagging problems that can occur in ceiling tiles without the facing 24.

In addition, applicant has found that the aluminum construction facing 24 is an energy saving component that enables the tile 10 to reduce the need for extra energy for heating and cooling purposes in the environment where the ceiling tile 10 is installed. Also, the aluminum construction facing 24 improves the retention of cool air in the summer and the retention of warm air in the winter, in basement locations, as well as at upper levels of a home or building where the ceiling tile 10 is installed.

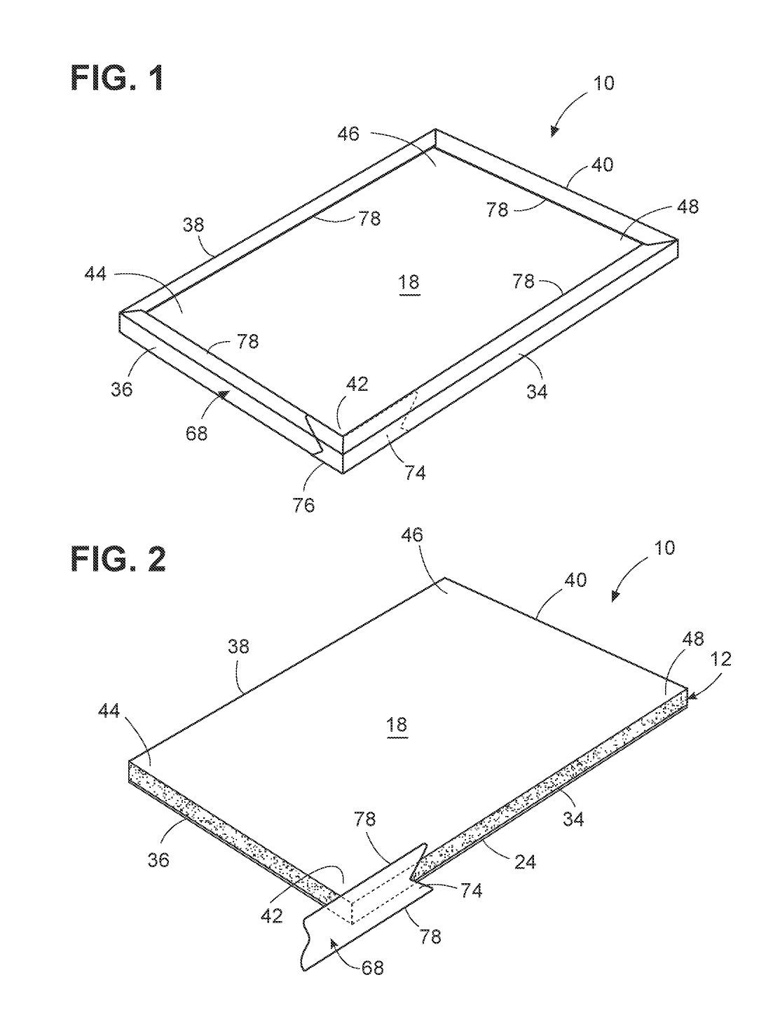

The ceiling tile 10 further includes a water resistant adhesive tape 68 (FIGS. 1 and 2), preferably formed of vinyl, to cover the side edges 34, 36, 38 and 40 of the ceiling tile. The adhesive tape 68 is preferably a one piece vinyl strip having opposite ends 74 and 76 that overlay each other at one corner of the tile, such as the corner 42 (FIG. 1). The tape 68 can be wound around the edges 34, 36, 38, and 40 of the mineral fiber layer 12 (FIG. 2) in any suitable known manner or in the manner shown in my U.S. Pat. No. 8,227,068, which is hereby incorporated by reference herein.

The width of the adhesive tape 68 between opposite edge portions 78, 78 is sized to ensure that opposite edge portions 78, 78 of the tape 68 are folded over onto peripheral marginal portions of the front surface 18 and the aluminum construction facing 24 of the tile 10.

The tape 68 prevents moisture from penetrating through the edges 34, 36, 38 and 40 of the ceiling tile, an I also serves as a reinforcement to inhibit breakage or fracture of the mineral fiber layer 12 at the edges 34, 36, 38 and 40, and at the corners 42, 44, 46, and 48. Furthermore, the tape 68 prevents the emission of any volatile organic compounds from the edges of the ceiling tile 10.

When the ceiling tile 10 is installed as a hung ceiling, the tile 10 is usually held in a known ceiling tile support frame (not shown). The known ceiling tile support frames support the peripheral marginal edges of the ceiling tiles and may also permit drop-in installation of the ceiling tiles. Since the ceiling tile support frame supports the peripheral marginal portions of the tile 10 only the exposed front surface 18 of the ceiling tile 10 is visible to occupants of the space below the hung ceiling tiles. Thus the folded over edge portions 78 of the tape 68 on the exposed front surface 18 of the ceiling tile 10 are concealed by the ceiling tile support frames and are not visible in the space below the ceiling tile because there is no visual exposure of the tape 68 when the ceiling tiles 10 are in a support frame.

Applicant has also found that the edge protection tape 68 also provides protection against installation damage to the tile 10 in a suspension system that has minimal clearance between the peripheral edges 34, 36, 38 and 40 and the tile suspension framework (not shown).

The outside dimensions of the ceiling tile 10 are a matter of choice. For example, the ceiling tile 10 can be two feet by two feet for a square tile and two feet by four feet for a rectangular tile, although other dimensions are feasible.

It should also be noted that the aluminum construction facing 24 and the edge protection tape 68 do not add any significant weight to the overall weight of the tile 10.

As various changes can be made in above constructions and methods without departing from the scope of the invention, it is intended that all matter contained in the above description or shown in the accompanying drawings shall be interpreted as illustrative and not in a limiting sense.

What is claimed is:

1. A ceiling tile for installation on or below a ceiling surface comprising,
a) a rigid layer formed of mineral fiber material having a multi-sided polygonal periphery with peripheral edges and having a first-display surface exposed for viewing when the ceiling tile is in an installed position on or below a ceiling surface said display surface having a marginal peripheral portion, and said rigid layer having a second surface opposite the first surface,
b) a moisture resistant facing formed with a metallic in material, said facing being bonded to the second surface of said rigid layer to prevent moisture from penetrating the rigid layer through the second surface, said facing having a marginal peripheral portion, and
c) a moisture resistant, gas-tight tape formed of plastic material enveloping the multi-sided periphery of the rigid layer at the peripheral edges, and overlapping and adhering to the marginal peripheral portion of the facing and the first-display surface to prevent moisture from penetrating the rigid layer through the peripheral edges, and to prevent any volatile organic compounds from the rigid layer from exiting the rigid layer at the peripheral edges.

2. The ceiling tile as claimed in claim 1 wherein the facing is formed of an aluminum construction.

3. The ceiling tile as claimed in claim 2 wherein the aluminum construction includes an aluminum foil facing with a fiberglass scrim and a kraft paper base bonded to the second surface of said rigid layer such that the aluminum foil facing is at the outside of the second surface of said rigid layer.

4. The ceiling tile as claimed in claim 2 wherein the aluminum construction is formed of an aluminum composite that includes a combination of aluminum powder and polyethylene.

5. The ceiling tile as claimed in claim 4 wherein the aluminum powder comprises about 1% to 3% by weight of the composite.

6. The ceiling tile as claimed in claim 1 wherein the plastic tape is formed of a self-adhesive, moisture resistant, leak tight vinyl material resistant to passage of moisture through the tape from the outside of the tape to the rigid layer, and resistant to the passage of any gaseous vapors from the rigid layer through the tape.

7. The ceiling tile as claimed in claim 1 wherein the plastic tape is a one piece strip of self-adhesive tape.

8. The ceiling tile as claimed in claim 7 wherein the strip of plastic tape surrounds the multi-sided polygonal periphery and has one end located at one corner of the polygonal periphery and an opposite end also located at the one corner of the polygonal periphery.

9. The ceiling tile as claimed in claim 8 wherein the two opposite ends of the plastic tape overlap one corner of the multi-sided polygonal periphery and also overlap each other at the one corner of the multi-sided polygonal periphery.

10. The ceiling tile as claimed in claim 9 wherein the polygonal multi-sided periphery of the ceiling tile has intersecting edges that define corners of the tile, and wherein the plastic tape has overlapping portions at the corners of the ceiling tile other than the one corner.

11. The ceiling tile as claimed in claim 1 wherein the leak-tight tape has two marginal edge portions, one of said marginal edge portions overlapping the marginal periphery of the display surface of the rigid layer, and the other marginal edge portion overlapping the marginal periphery of the moisture resistant facing.

12. The ceiling tile as claimed in claim 1 wherein the ceiling tile has a rectangular periphery.

13. A method of making a ceiling tile comprising,
a) providing a rigid layer formed of mineral fiber material having a multi-sided polygonal periphery with peripheral edges and a first display surface exposed for viewing when the ceiling tile is in an installed position on or below a ceiling surface, the display surface having a marginal peripheral portion, and the rigid layer having a second surface opposite the first surface,
b) providing a moisture resistant facing formed with a metallic or metallic composite material, and bonding the facing to the second surface of the rigid layer to prevent moisture from penetrating the rigid layer through the second surface, the facing having a marginal peripheral portion, and
c) providing a moisture resistant, gas-tight tape formed of plastic material to surround the multi-sided periphery of the rigid layer at is the peripheral edges, and overlapping and adhering the tape to the marginal peripheral portion of the facing and the marginal peripheral portion of the first display surface to prevent moisture from penetrating the rigid layer through the peripheral edges and through the facing, and to prevent any noxious gases from the rigid layer from exiting the rigid layer at the peripheral edges and the facing.

14. The method of claim 13 including forming the facing of an aluminum construction that includes an aluminum foil facing with a fiberglass scrim and a kraft paper base and bonding the kraft paper base to the second surface of the rigid layer such that the aluminum foil facing is at the outside of the second surface of the rigid layer.

15. The method of claim 13 including fanning the facing of a metallic composite that includes a combination of aluminum powder and polyethylene.

16. The method of claim 15 wherein the aluminum powder is approximately 1% to 3% by weight of the composite.

17. The method of claim 13 including forming the plastic tape of a self-adhesive leak tight vinyl material resistant to passage of moisture and gaseous vapors.

18. The method of claim 13 including providing the leak-tight tape with two marginal edge portions, overlapping one of the marginal edge portions onto the marginal periphery of the display surface of the rigid layer and overlapping the other marginal edge portion of the tape onto the marginal periphery of the facing.

19. The method of claim 18 including limiting the amount of tape overlap on the marginal periphery of the display surface to an amount that is concealed by a ceiling tile support frame when the ceiling tile is installed in a hung ceiling arrangement in a ceiling tile support frame.

20. The method of claim 13 including fanning the ceiling tile with a rectangular periphery.
